(19) United States
(12) Patent Application Publication
(10) Pub. No.: US 2024/0196482 A1
(43) Pub. Date: Jun. 13, 2024

(54) Induction Cooktop and Method for Controlling an Induction Cooktop

(71) Applicant: SABAF S.P.A., Ospitaletto (IT)

(72) Inventors: Cristiano Pastore, Ospitaletto (IT); Salvatore Restivo, Ospitaletto (IT)

(73) Assignee: SABAF S.P.A., Ospitaletto, BS (IT)

(21) Appl. No.: 18/532,616

(22) Filed: Dec. 7, 2023

(30) Foreign Application Priority Data
Dec. 9, 2022 (EP) 22212495.0

(51) Int. Cl. H05B 1/02; H05B 6/12

(52) U.S. Cl. CPC H05B 1/0266; H05B 1/0202; H05B 6/12

(57) ABSTRACT

An induction cooktop is provided that includes a first induction heater and a second induction heater; a control unit; a first switching converter and a second switching converter, operable, preferably cyclically, by the control unit in a control period to energize the first induction heater and the second induction heater, respectively; wherein the control unit is configured to operate, preferably in a first working mode, and wherein: (i) during at least a first fraction of the control period operate simultaneously the first switching converter with a first switching frequency value and the second switching converter with a second switching frequency value, wherein a frequency switching difference between the two switching frequencies values is equal to a value comprised between a first frequency threshold and a second frequency threshold or is above a third frequency threshold.

### CROSS-REFERENCE TO RELATED APPLICATIONS

This patent application claims priority from European patent application no. 22212495.0 filed on Dec. 9, 2022, the entire disclosure of which is incorporated herein by reference.

### TECHNICAL FIELD

The present invention relates to an induction cooktop and method for controlling an induction cooktop.

### BACKGROUND

As it is known, an induction cooktop may comprise at least one pair of high frequency switching converter, sharing common mains line, in particular sharing a same phase of the common mains line, rectifier and DC link and configured to energize respective induction heaters (also referred to as “pancake coils”).

Known solutions for controlling two induction heaters are described in EP 1 951 003 A1 and in EP 1 878 309 B1.

EP 1 951 003 A1 discloses a control method for activating simultaneously two induction heaters, wherein the duration of the control period is divided in two fractions of the control period: in the first fraction of the control period, both induction heaters are fed simultaneously at the same first switching frequency value; and in the second fraction of the control period, only one induction heater is fed at a second switching frequency value preferably different from the first switching frequency value, while the other induction heater is not fed.

EP 1 878 309 B1 discloses a method for supplying power to a plurality of induction heaters operating in two modes: with a first mode at the same frequency value so to produce no intermodulation or differential frequency, and a second mode having a high difference of frequency of about 18 kHz.

However, known solutions do not allow to use some combinations of desired powers of the first induction heater and the second induction heater. In other words, the control strategy of the know art defines a plurality of combinations of absorbed powers of the first induction heater and the second induction heater, but such plurality of combinations do not comprise some other combinations of powers that would be available from the mains power.

In other word, the control strategies of the know art do not allow to supply the first and the second induction heater with some values of absorbed powers for the first induction heater and the second induction heater in some circumstances.

### SUMMARY OF THE INVENTION

It is an aim of the present invention to provide an induction cooktop and a method for controlling an induction cooktop that overcomes or at least reduces the above limitations.

In exemplary embodiments, an induction cooktop is provided that includes a first induction heater and a second induction heater; a control unit; a first switching converter and a second switching converter, operable, preferably cyclically, by the control unit in a control period to energize the first induction heater and the second induction heater, respectively; wherein the control unit is configured to operate, preferably in a first working mode, and wherein: (i) during at least a first fraction of the control period operate simultaneously the first switching converter with a first switching frequency value and the second switching converter with a second switching frequency value, wherein a frequency switching difference between the two switching frequencies values is equal to a value comprised between a first frequency threshold and a second frequency threshold or is above a third frequency threshold.

Thus, according to the present invention there are provided an induction cooktop and a method of controlling an induction cooktop as described herein with reference to the accompanying figures.

### BRIEF DESCRIPTION OF THE DRAWINGS

The present invention will now be described with reference to the accompanying drawings, which show a number of non-limitative embodiments thereof, in which:

FIG. 1 is a simplified block diagram of an induction cooktop in accordance with an embodiment of the present invention;

FIG. 2 is a circuit diagram of components of the induction cooktop of FIG. 1;

FIG. 3 is a graph wherein on the x-axis are first power values P₁ for the first induction heater and on the y-axis are second power values P₂ for the second induction heater;

FIG. 4 is a graph showing quantities in a control period of the induction cooktop of FIG. 1 in a first mode of working of the control unit;

FIG. 5 is a graph showing quantities in a control period of the induction cooktop of FIG. 1 in a second mode of working of the control unit;

FIG. 6 is a graph showing quantities in a control period of the induction cooktop of FIG. 1 in a third mode of working of the control unit;

FIG. 7 is a circuit diagram of components of an induction cooktop in accordance with another embodiment of the present invention.

### DETAILED DESCRIPTION OF EMBODIMENTS

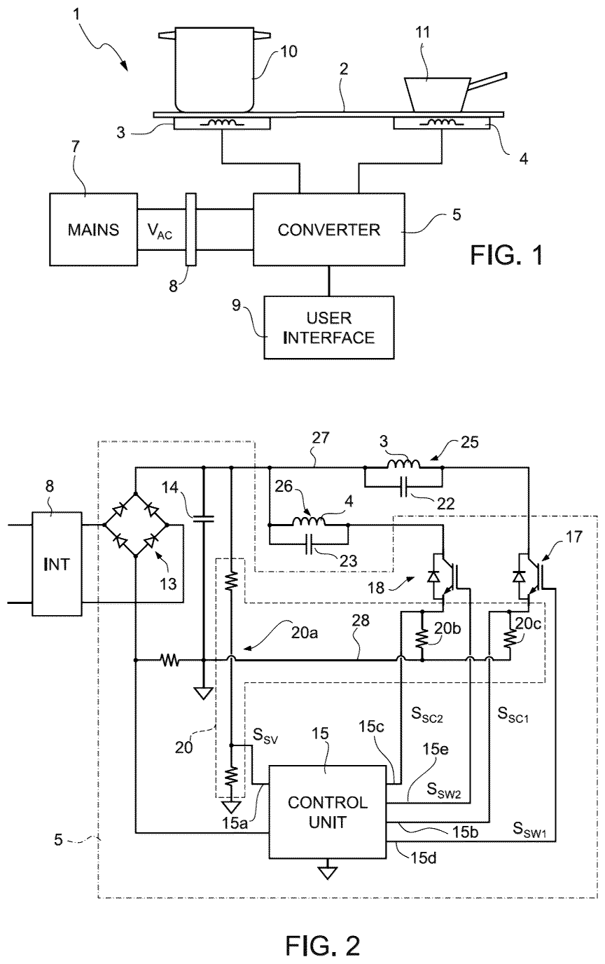

With reference to FIG. 1, an induction cooktop is designated as a whole by number 1 and comprises a glass-ceramic plate 2, at least a pair of induction heaters including a first induction heater 3 and a second induction heater 4 at respective cooking zones below the plate 2, and a converter assembly 5, configured to be coupled to a supply line (mains) 7 through a coupling interface 8 to receive an AC supply voltage V_{AC} and to independently energize the induction heaters 3, 4. The coupling interface 8 allows connection to the supply line 7 and may include a terminal block and EMI (Electro-Magnetic Interference) suppression filters (not shown).

In particular, the first induction heater 3 and the second induction heater 4 are supplied by means of the converter assembly 5 from a common main phase of the supply line 7.

The first induction heater 3 and the second induction heater 4 are inductors.

The induction cooktop 1 is configured to be coupled to the supply line (mains) 7, to receive an AC supply voltage V_{AC} from the supply line 7 and to energize at least one of the induction heaters 3, 4.

In embodiments not shown, an induction cooktop may include a plurality of pairs of induction heaters, each pair of induction heaters being supplied by one respective common mains phase.

A user interface 9 allows users to select average power levels to be delivered to the induction heaters 3, 4.

In use, induction cooking vessels 10, 11 are arranged at the cooking zones in positions corresponding to respective induction heaters 3, 4. When the induction heaters 3, 4 are energized, Eddy currents are induced in the cooking vessels 10, 11, which are thus heated.

In accordance with a non-limiting embodiment of the present invention illustrated in FIG. 2, the converter assembly 5 comprises a rectifier 13; a DC bus 14, in particular a DC link capacitor; a control unit 15; a first high frequency switching converter 17, in particular a first power switch; a second high frequency switching converter 18, in particular a second power switch; and a power detector 20, that in turn includes a voltage sensing network 20a and current sensors 20b, 20c. The first induction heater 3 and the second induction heater 4 with respective resonant capacitors 22, 23 form a first resonant circuit 25 and a second resonant circuit 26, respectively driven by the first high frequency switching converter 17 and the second high frequency switching converter 18, which are operated as switching converters by the control unit 15. Further, in a preferred embodiment, the first high frequency switching converter 17 and the second high frequency switching converter 18 are supplied from a common phase of the mains 7.

In the embodiment of FIG. 2, the first high frequency switching converter 17 is in single-ended quasi-resonant configuration topology that converts a DC current to an AC current to supply the first resonant circuit 25. The second high frequency switching converter 18 is in single-ended quasi-resonant configuration topology that converts a DC current to an AC current to supply the second resonant circuit 26.

The first power switch of the first high frequency switching converter 17 and the second power switch of second high frequency switching converter 18 may be any suitable kind of device, such as IGBTs or power MOSFETs. It is also understood that the converters are not limited to the quasi-resonant configuration and other configuration may be exploited as well, such as a half-bridge configuration as explained in detail later on.

The rectifier 13 and the DC link capacitor 14 supply a rectified voltage to rails 27, 28 and the control unit 15 controls the high frequency switching converters 17, 18 to energize the induction heaters 3, 4 and deliver power to the cooking vessels 10, 11 in accordance with user's requests.

In a preferred embodiment, not limiting the scope of protection, the power detector 20 is configured to continuously sense an active power individually delivered by each of the induction heaters 3, 4 to the cooking vessels 10, 11 and, in the non-limiting embodiment of FIG. 2, includes the voltage sensing network 20a and the current sensors 20b, 20c, as already mentioned. The voltage sensing network 20a may include a voltage divider connected between the rails 27, 28 and having an intermediate node coupled to a voltage sense input 15a of the control unit 15. The current sensors 20b, 20c may include resistors in series to conduction terminals of respective power switches of the respective high frequency switching converters 17, 18 and are coupled to respective current sense input 15b, 15c of the control unit 15. It is however understood that any suitable power detector may be used in place of the power detector 20 of FIG. 2, including power detectors with common current sensors for the respective power switches of the respective high frequency switching converters 17, 18. The power detector 20 supplies power sense signals, based on which the control unit 15 determines the active power delivered by the high frequency switching converters 17, 18. In the non-limiting embodiment of FIG. 2, power sense signals include a voltage sense signal S_{SV} supplied by the voltage sensing network 20a and current sense signals S_{SC1}, S_{SC2} supplied the current sensors 20b, 20c, respectively.

The control unit 15 has control outputs 15d, 15e coupled to control terminals of respective high frequency switching converters 17, 18 and is configured to operate the high frequency switching converters 17, 18 on the basis of a control procedure and in accordance with user's requests so as to energize the induction heaters 3, 4 and deliver power to the cooking vessels 10, 11. Further, in a preferred embodiment the control unit 15 operates the first high frequency switching converter 17 and the second high frequency switching converter 18 also on the basis of power measurements received from or based on the power sense signals S_{SV}, S_{SC1}, S_{SC2} provided by the power detector 20.

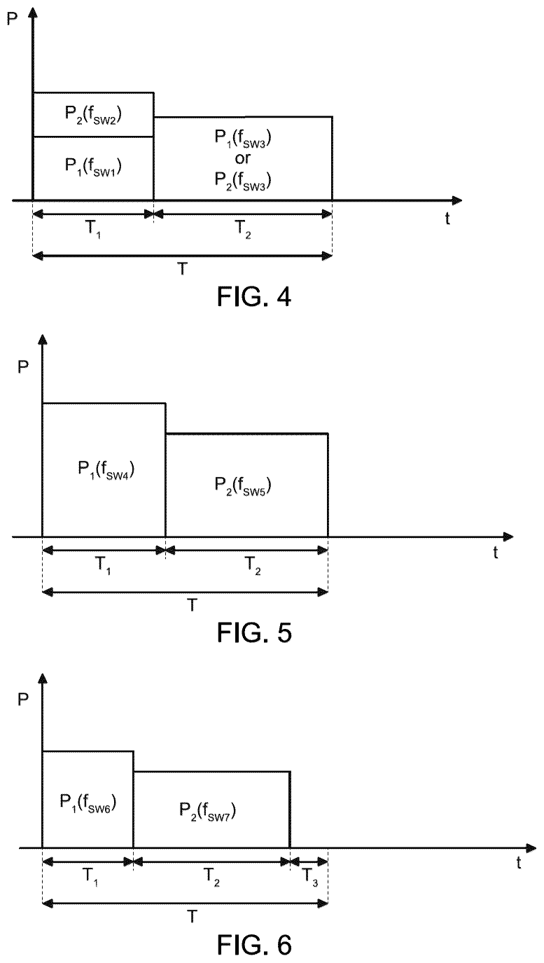

Specifically, the high frequency switching converters 17, 18 are operated on control cycles having a control period T, one of which is shown in FIGS. 4, 5 and 6.

With reference to FIGS. 1-5, each control period T includes a plurality of control intervals, in particular two or three control intervals, in which the first power switch of the first high frequency switching converter 17 and the second power switch of the second high frequency switching converter 18 are operated by the control unit 15 at respective controlled switching frequencies f_{A}, f_{B} (FIG. 2) through a first control signal S_{SW1} and a second control signal S_{SW2}, respectively. The control signals S_{SW1}, S_{SW2} are provided on the control outputs 15d, 15e of the control unit 15 and applied to the control terminals of the respective high frequency switching converters 17, 18.

In other words, the first power switch of the first high frequency switching converter 17 is operated by the control unit 15 at the switching frequency f_{A}, which can be controlled for assuming different values.

The second power switch of the second high frequency switching converter 18 is operated by the control unit 15 at the switching frequency f_{B}, which can be controlled for assuming different values.

In particular, the control unit 15 is configured to operate in a plurality of working modes, in particular a first mode, a second mode and a third mode.

With reference to FIG. 4, in the first mode the control unit 15 is configured so that during a at least a first fraction T₁ of the control period T operates simultaneously the first switching converter 17 with a first switching frequency value f_{SW1} and the second switching converter 18 with a second switching frequency value f_{SW2}, wherein the first switching frequency value f_{SW1} and the second switching frequency value f_{SW2} are different between them.

In a particular embodiment, the control unit 15 selects the first switching frequency value f_{SW1} for the switching frequency f_{A} and the second switching frequency value f_{SW2} for the switching frequency f_{B} in such a manner that the cooktop 1 does not produce audible acoustic noise.

The control unit 15 calculates a switching frequency difference Δf as an absolute value of the difference between the value of the switching frequency f_{A} and the value of switching frequency f_{B}.

In an embodiment, when the value of the switching frequency f_{A} is greater than the value of the switching frequency f_{B} the control unit 15 calculates a switching frequency difference Δf as given from the value of switching frequency f_{A} minus the value of the switching frequency f_{B}, when the value of the switching frequency f_{B} is greater than the value of the switching frequency f_{A} the control unit 15 calculates the switching frequency difference Δf as given from the value of switching frequency f_{B} minus the value of the switching frequency f_{A}.

In particular, in an embodiment, the control unit 15 selects the first switching frequency value f_{SW1} and the second switching frequency value f_{SW2} in such a manner that the switching frequency difference Δf is equal to a value selected in a range from a frequency difference threshold Δf1 to a frequency difference threshold Δf2 and preferably is not a integer multiple of the alternate current frequency of the Mains (that usually is 50 Hz or 60 Hz).

In particular, the frequency difference threshold Δf1 is equal to 51 Hz.

The frequency difference threshold Δf2 is equal to a value comprised in a range from 200 Hz to 500 Hz, preferably the frequency difference threshold Δf2 is equal to 200 Hz or 500 Hz.

In particular, in an embodiment, the control unit 15 selects the first switching frequency value f_{SW1} and the second switching frequency value f_{SW2} in such a manner that the switching frequency difference Δf is greater than the frequency difference threshold Δf3 and preferably said difference is not a integer multiple of the alternate current frequency of the Mains (that usually is 50 Hz or 60 Hz).

In particular, the frequency difference threshold Δf3 and is equal to 5 kHz.

In other words, in the first mode the control unit 15 selects the first switching frequency value f_{SW1}, and the second switching frequency value f_{SW2} so that the switching frequency difference Δf is comprised between 51 Hz and the frequency difference threshold Δf2, or is above 5 kHz. Further, in both cases preferably the control unit 15 selects the first switching frequency value f_{sw1} and the second switching frequency value f_{SW2} so that the switching frequency difference Δf is not a multiple of the alternate current frequency of the Mains (that usually is 50 Hz or 60 Hz).

Further in an embodiment, in the first mode, the control unit 15 operates during a second fraction T₂ of the control period T only one of the first and second switching converter 17 or 18 with a third frequency switching value f_{SW3} for the switching frequency f_{A} or for the switching frequency f_{B}, preferably the other of the first and second switching converter 17 or 18 being not operating or halting or idling. The third switching frequency value f_{SW3} can be equal to the first switching frequency value f_{SW1} or to the second switching frequency value f_{SW2} or different from the first switching frequency value f_{SW1} and second switching frequency value f_{SW2}.

In particular, in the first mode, the control unit 5 selects the first fraction T₁ and the second fraction T₂ of the control period T so that the first fraction T₁ of the control period T and the second fraction T₂ of the control period T are preferably not overlapping, in other words preferably the sum of the first fraction T₁ and the second fraction T₂ is equal to the duration of control period T.

In the first mode, the second fraction T₂ of the control period can be equal to zero, hence can be absent.

In other words, in another embodiment of the present invention, in the first mode, the second fraction T₂ of the control period is equal to zero and the first fraction T₁ is equal to the period T. Hence in this embodiment, the control unit 15 is configured so that during the control period T, in particular during all the duration of the control period T, operates simultaneously the first switching converter 17 with a first switching frequency value f_{SW1} and the second switching converter 18 with a second switching frequency value f_{SW2}, wherein the first switching frequency value f_{SW1} and the second switching frequency value f_{SW2} are different between them.

Further, the control unit 15 is configured to operate in some circumstances according to the second mode.

With reference to FIG. 5, in the second mode, the control unit operates the first switching converter 17 with a fourth switching frequency value f_{sw4} in a first fraction T₁ of the control period T while the second switching converter 18 is not operating.

Further, in the second mode the control unit operates the second switching converter 18 with a fifth switching frequency value f_{sw5} in a second fraction T₂ of the control period T₂ while the first switching converter 18 is not operating.

Further, the fourth switching frequency value f_{sw4} can be the same or different from the first, second, third or fifth switching frequency value f_{SW1}, f_{sw2}, f_{sw3}, f_{sw5}.

Further, the fifth switching frequency value f_{sw5} can be the same or different from the first, second, third or fourth switching frequency value f_{SW1}, f_{sw2}, f_{sw3}, f_{sw5}.

In the second mode, the first fraction T₁ of the control period T and the second fraction T₂ of the control period T are not overlapping, in other words the sum of the first fraction and the second fraction is equal to the duration of time period. In other words, the first switching converter 17 and the second switching converter 18 works in alternated mode (the first converter 17 for the first fraction T₁ and the second converter 18 for the second fraction T₂) without a time gap in the control period T.

In particular, further, the control unit 15 is configured to operate in some circumstances according to the third mode.

With reference to FIG. 6, in the third mode the control unit 15 operates the first switching converter 17 with a sixth switching frequency value f_{SW6} in a first fraction T₁ of the control period T while the second switching converter 18 is not operating;
operate the second switching converter 18 with a seventh switching frequency value f_{SW7} in a second fraction T₂ of the control period T while the first switching converter 18 is not operating;
and the control unit 15 in a third fraction T₃ of the control period holds both the first and the second switching converter not operating or halting or idling.

Also, in this case the first fraction T₁ of the control period T and the second fraction T₂ of the control period T are not overlapping preferably. Further, the sum of the first fraction T₁ and the second fraction T₂ is lower than the time period T because there is also a third fraction T₃ of the control period T where no switching converter are operating. In other words, the first switching converter 17 and the second switching converter 18 works in alternated mode (the first converter 17 for the first fraction T₁ and the second converter 18 for the second fraction T₂) with a time gap.

In this document the sentence “the control unit operates a high frequency converter with a given frequency switching value” means that control unit 15 provides to the respective frequency converter 17, 18 the respective control signals S_{SW1}, S_{SW2} so that the switching of the respective converter 17, 18 have the respective given frequency value, in particular the respective power switch of the respective power converter 17, 18 switches according to the respective given frequency value. In an embodiment, the control signal is a signal having a frequency corresponding to the given frequency value.

In particular, the control unit 15 defines the first fraction T₁ of the time period T and the second fraction T₂ of the time period T on the basis of the each power demand of the respective inductive heaters.

Further, the value of the first fraction T₁ of the time period T and the value of second fraction T₂ of the time period T can vary during the first mode and/or the second mode and/or the third mode and/or between the first mode and/or the second mode and/or the third mode.

In a preferred embodiment not limiting the scope of protection, the control unit 15 selects one working mode from the plurality of working modes on the basis of the power target to be delivered, in particular the control unit 15 is configured to calculate a power target to be delivered based on the user's requests by the user interface 9 and selects one working mode from the plurality of working modes on the basis of the calculated power target to be delivered.

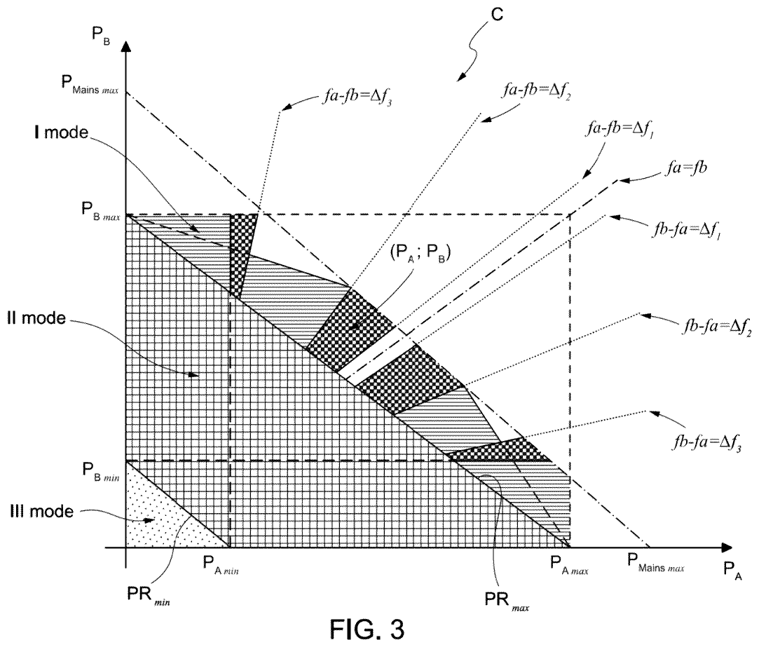

With reference to the FIG. 3, in a preferred embodiment, the control unit 15 is configured to calculate a power target couple given by a first power value P_{A} for the first induction heater 3 and a second power value P_{B} for the second induction heater 4 to be delivered based on the user's requests by the user interface 9.

In particular, in FIG. 3 it is shown a chart C memorized in the control unit 15 wherein on the x-axis are power values request P_{A} for the first induction heater 3 and on the y-axis are power values request P_{B} for the second induction heater 4. In particular, in FIG. 3 is represented the control strategy versus the power value request P_{A} for the first induction heater 3 and the power value request P_{B} for the second induction heater 4.

In the chart C are defined three regions that corresponds to the three working modes disclosed above.

In particular, the three regions are defined by two lines PRₘₐₓ and PRₘᵢₙ.

The first line PRₘₐₓ is the line that passes for the two points of the chart P_{A}=P_{Amax}; P_{B}=0 and P_{A}=0; P_{B}=P_{Bmax}
wherein P_{Amax} is preferably selected as the maximum power that the first switching converter can feed to the first inductor and P_{Bmax} is preferably selected as the maximum power that the second switching converter can feed to the second inductor.

The second line PRₘᵢₙ is the line that passes for the two points of the chart P_{A}=P_{Amin}; P_{B}=0 and P_{A}=0; P_{B}=P_{Bmin};
wherein P_{Amin} is preferably selected as the minimum power value wherein the first switching converter can feed to the first inductor in continuous mode (i.e wherein the sum of the first fraction T₁ of the period T and the second fraction T₂ of the period T is equal to the period T, and/or without gap in the control period) and P_{Bmin} is preferably selected as the minimum power value wherein the second switching converter can feed to the second inductor in continuous mode (i.e wherein the sum of the first fraction of the period and the second fraction of the period is equal to the period, and/or without gap in the control period).

Further, preferably the maximum power value P_{Amax} and PBₘₐₓ are achieved at the lowest operable frequency by the high frequency converters without incurring in electrical or thermal overstress. Similarly, preferably the P_{Amin} and P_{Bmin} denotes the minimum continuous power value achieved at the lowest operable frequency by the converter without incurring in electrical or thermal overstress.

In particular, in the chart the line PRₘᵢₙ is below to the line PRₘₐₓ.

In particular, the control unit 15 comprises a memory wherein is stored the said chart C and selects the control mode based on the power values request P_{A}, P_{B} to be delivered based on the user's requests.

In particular, the control unit 15 operates according to the first mode preferably when on the chart C a working point defined by the couple of power values request P_{A}, P_{B} lies above the first line PRₘₐₓ (the line on the chart C passing by the points (0, P_{Bmax}) and (P_{Amax}, 0)).

Preferably, the control unit 15 operates according to the second mode when on the chart C the working point (defined by the couple of power target values request P_{A}, P_{B}) is comprised between the second line PRₘᵢₙ and the first line PRₘₐₓ.

Preferably, the control unit 15 operates according to the third mode when on the chart C the working point (defined by the couple of power target values request P_{A}, P_{B}) is lying below the second line PRₘᵢₙ (the line on the chart C passing by the points (0, P_{Bmin}) and (P_{Amin}, 0).

In particular, when the point on the chart C defined by power target values request is below the PRₘᵢₙ any combination of power values request P_{A}, P_{B} couple can be achieved by any combination of power and times obeying to the following set of equations

$$\{ \begin{matrix}{P}_{A} = \{ {P}_{A} ( {f}_{SW 4 , SW 6} ) * {T}_{1} \} / T \\ {P}_{B} = \{ {P}_{B} ( {f}_{SW 5 , SW 7} ) * {T}_{2} \} / T\end{matrix}$$

In the second mode T₁+T₂=T, while in the third mode T₁+T₂<T.

In other words, in order to achieve power value request P_{A}, P_{B} in the third mode an alternated mode with gap must be used, whereas in second mode it is possible to satisfy the power value request with pure inverter/inductor alternation, in a continuous mode of the control period T i.e. with no gap within the control period T.

Further, when the point on the chart C defined by power target values request P_{A}, P_{B} is above the line PRₘₐₓ the combination of power and times obeying to the following sets of equations:

$$\{ \begin{matrix}{P}_{A} = \{ {P}_{A} ( {f}_{sw 1} ) * {T}_{1} + {P}_{A} ( {f}_{sw 3} ) * {T}_{2} \} / T \\ {P}_{B} = \{ {P}_{B} ( {f}_{sw 2} ) * {T}_{1} \} / T\end{matrix} \qquad ( 1 )$$

$$or$$

$$\{ \begin{matrix}{P}_{A} = \{ {P}_{A} ( {f}_{sw 1} ) * {T}_{1} \} / T \\ {P}_{B} = \{ {P}_{B} ( {f}_{sw 2} ) * {T}_{1} + {P}_{B} ( {f}_{sw 3} ) * {T}_{2} \} / T\end{matrix} \qquad ( 2 )$$

Wherein when P_{A} is greater than P_{B} is used the set of equations (1), when P_{B} is greater than P_{A} is used the set of equations (2).
wherein P_{A} and P_{B} are a first power value request and a second power value request for the first induction heater 3 and the second induction heater 4, respectively; P_{A}(f_{SW1}), P_{A}(f_{SW3}) indicate power delivered by the first induction heater 3 when operated at the first switching frequency value f_{SW1}, at the third switching frequency value f_{SW3}, respectively; P_{B}(f_{SW2}) and P_{B}(f_{SW3}) indicate power delivered by the second induction heater 4 when operated at the second switching frequency value f_{SW2}, at the third at the third switching frequency value f_{SW3}, respectively; T₁ and T₂ are the respective fraction of the control period T.

During each of the control intervals, the control unit 15 measures respective values of power delivered on the basis of the power sense signals S_{SV}, S_{SC1}, S_{SC2} continuously received from the power detector 20 and the user request received by the user interface and defines the working mode.

The quasi-resonant configuration of the converter is particularly advantageous. Quasi-resonant converters are widely used as high frequency power supply for induction cooktops and proved to be particularly attractive as being structurally simple and inexpensive, because a single solid state power switch (typically an IGBT) and a single resonant capacitor are required for each induction coil. Quasi-resonant converters are also very well suited to the above described control because of fairly linear relationship between delivered power and switching period. In fact, interpolation is simple and accurate, which is a favorable property to achieve good and efficient power control.

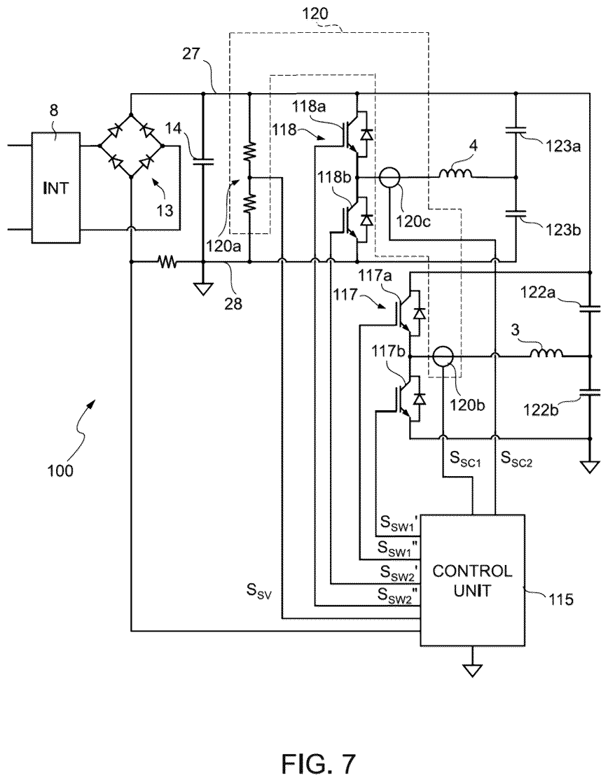

The converter need not be in quasi-resonant configuration, however. In the embodiment of FIG. 7, for example, where parts already described are indicated by the same reference numbers, an induction cooktop 100 the first induction heater 3, the second induction heater 4 and a converter 105, configured to couple to the supply line 7 through the coupling interface 8 and to independently energize the induction heaters 3, 4. The converter 105 comprises the rectifier 13, the DC link capacitor 14, a control unit 115, a first switching converter 117, a second switching converter 118 and a power detector 120. The first switching converter 117 and the second switching converter 118 comprises two first power switches 117a, 117b and the second switching converter 118 comprises two second power switches 118a, 118b in half-bridge configuration. Specifically, the first induction heater 3 forms a first resonant circuit 125 driven by the first switching converter 117 with respective first resonant capacitors 122a, 122b and the second induction heater 4 forms a second resonant circuit 126 driven by the second switching converter 118 with respective second resonant capacitors 123a, 123b.

The power detector 120 comprises a voltage sensing network 120 and current sensors 120b, 120c and supplies power sense signals, based on which the control unit 115 determines the active power delivered by the switching converters 117, 118. The voltage sensing network 120a may include a voltage divider connected between the rails 27, 28 and having an intermediate node coupled to a voltage sense input of the control unit 115 to provide a voltage sense signal S_{SV}. The current sensors 120b, 120c are configured to sense currents supplied by the switching converters 117, 118, respectively, and to provide corresponding current sense signals S_{SC1}, S_{SC2} to current sense inputs of the control unit 115. The power sense signals supplied by the power detector 120 include the voltage sense signal S_{SV} and the current sense signals S_{SC1}, S_{SC2}.

The first switching converter 117 and the second switching converter 118 are operated by the control unit 115 at the switching frequencies values f_{SW1}-f_{SW7} in the fractions T1 and/or T2 and and/or T3 of each control period T. For this purpose, the control unit 115 supplies first control signals S_{SW1}′, S_{SW1}″ to control terminals of the power switches 117a, 117b of the first switching converter 117 and second control signals S_{SW2}′, S_{SW2}″ to control terminals of the second switching converter 118.

Finally, it is clear that modifications and variants can be made to the cooktop and to the method described herein without departing from the scope of the present invention, as defined in the appended claims.

1. An induction cooktop comprising:
a first induction heater (3) and a second induction heater (4);
a control unit (15; 115);
a first switching converter (17; 117) and a second switching converter (18; 118), operable by the control unit (15; 115) in a control period (T) to energize the first induction heater (3) and the second induction heater (4), respectively;
wherein the control unit (15; 115) is configured to operate in a first working mode, wherein:
during at least a first fraction (T₁) of the control period (T) operate simultaneously the first switching converter (17; 117) with a first switching frequency value (f_{SW1}) and the second switching converter (18; 118) with a second switching frequency value (f_{SW2}); wherein a switching frequency difference (Δf) between the two switching frequencies values (f_{SW1}, f_{SW2}) is greater than zero and is equal to a value comprised between a first frequency threshold (Δf₁) and a second frequency threshold (Δf₂) or is above a third frequency threshold (Δf₃).

2. An induction cooktop according to claim 1, wherein in the first working mode, the control period (T) comprises a second fraction (T₂) in addition to the first fraction; during the second fraction (T₂) of the control period (T) the control unit is configured to operate only one of the first and second switching converter (17, 18; 117; 118) with a third switching frequency value (f_{SW3});
wherein the first fraction (T₁) of the control period (T) and the second fraction (T₂) of the control period (T) are not overlapping.

3. An induction cooktop according to claim 1, wherein said switching frequency difference (Δf) is not equal to an integer multiple of the alternate current frequency of the Main feeding the induction cooktop.

4. An induction cooktop according to claim 1, wherein the control unit (15; 115) is configured to operate in a plurality of modes comprising the first mode and at least a second mode; and when the control unit operates in the second mode it is configured to:
operate the first switching converter (17; 117) with a fourth switching frequency value (f_{SW4}) in a first fraction (T₁) of the control period (T) while the second switching converter (18) is not operating;
operate the second switching converter (18; 118) with a fifth switching frequency value (f_{SW5}) in a second fraction (T₂) of the control period (T) while the first switching converter (18) is not operating; wherein the first fraction (T₁) of the control period (T) and the second fraction (T₂) of the control period (T) are not overlapping; and
wherein the duration of the sum of the first fraction (T₁) and the second fraction (T₂) of the control period (T) is equal to the duration of the control period (T).

5. An induction cooktop according to claim 1,
wherein the plurality of modes comprises a third mode; and wherein when the control unit (15; 115) operates in the third mode, it is configured to:
operate the first switching converter (17; 117) with a sixth switching frequency value (f_{SW6}) in a first fraction (T₁) of the control period (T) while the second switching converter (18) is not operating;
operate the second switching converter (18; 118) with a seventh switching frequency value (f_{SW7}) in a second fraction (T₂) of the control period (T) while the first switching converter (18) is not operating;
during a third fraction (T₃) of the control period (T) both the first and the second switching converter (17, 18; 117, 118) being not operating or halting or idling.

6. The induction cooktop according to claim 1, wherein in the first mode, the control unit (15; 115) is further configured to determine the at least a first fraction (T₁) of the control period (T) from the following sets of equations:
$$\{ \begin{matrix}{P}_{A} = \{ {P}_{A} ( {f}_{sw 1} ) * {T}_{1} + {P}_{A} ( {f}_{sw 3} ) * {T}_{2} \} / T \\ {P}_{B} = \{ {P}_{B} ( {f}_{sw 2} ) * {T}_{1} \} / T\end{matrix} \\ or \\ \{ \begin{matrix}{P}_{A} = \{ {P}_{A} ( {f}_{sw 1} ) * {T}_{1} \} / T \\ {P}_{B} = \{ {P}_{B} ( {f}_{sw 2} ) * {T}_{1} + {P}_{B} ( {f}_{sw 3} ) * {T}_{2} \} / T\end{matrix}$$
wherein: P_{A} and P_{B} are a first power value request and a second power value request for the first induction heater (3) and the second induction heater (4), respectively; P_{A}(f_{SW1}), P_{A}(f_{SW3}) indicate power delivered by the first induction heater (3) when operated at the first switching frequency value (f_{SW1}) and at the third switching frequency value (f_{SW3}), respectively; P_{B}(f_{SW2}) and P_{B}(f_{SW3}) indicate power delivered by the second induction heater (4) when operated at the second switching frequency value (f_{SW2}) and at the third switching frequency value (f_{SW3}), respectively; T₁ and T₂ are the respective fractions of the control period T.

7. An induction cooktop according to claim 1, wherein, when the control unit (15; 115) is configured to operate in the first mode, the sum of the first fraction (T₁) of the control period (T) and the second fraction (T₂) of the control period (T) is equal to the control period (T).

8. An induction cooktop according to claim 1, wherein the control unit (15; 115) is configured to operate according to the first mode when a working point, on a chart (C), defined by the couple of first and the second power values request (P_{A}, P_{B}) of the first induction (3) and the second inductor (4) lies above a first line (PRₘₐₓ) on said chart (C);
wherein on the chart (C) on the x-axis are reported first power values request (P_{A}) for the first induction heater (3) and on the y-axis are second power values request (P_{B}) for the second induction heater (4);
wherein the first line (PRₘₐₓ) is defined as the line passing by the points P_{A}=0, P_{B}=P_{Bmax} and P_{A}=P_{Amax}, P_{B}=0 on the said chart (C);
wherein P_{Amax} is the maximum power that the first switching converter (17; 117) can feed to the first inductor (3) and P_{Bmax} is the maximum power that the second switching converter (18) can feed to the second inductor (4); and
wherein the chart (C) is stored in a memory of the control unit (15).

9. An induction cooktop according to claim 8, wherein the control unit (15) is configured to select the second mode when the working point on the chart (C) is comprised between a second line (PRₘᵢₙ) and the first line (PRₘₐₓ) on the chart (C); wherein the second line (PRₘᵢₙ) is the line that passes by the two points of the chart (C) P_{A}=P_{Amin}, P_{B}=0 and P_{A}=0, P_{B}=P_{Bmin}; wherein P_{Amin} is selected as the minimum power value wherein the first switching converter (17; 117) can feed to the first inductor (3) in a continuous mode, i without gap in the control period (t), and P_{Bmin} is selected as the minimum power value wherein the second switching converter (18; 118) can feed to the second inductor (4) in a continuous mode, without gap in the control period (T).

10. An induction cooktop according to claim 9, the control unit is configured to select the third mode when the working point on the chart (C) is lying below the second line (PRₘᵢₙ).

11. A control method for controlling an induction cooktop comprising a first induction heater (3), a second induction heater (4), a first switching converter (17; 117) and a second switching converter (18; 118); the first switching converter (17; 117) and a second switching converter (18; 118) being operable in a control periods (T) to energize the first induction heater (3) and the second induction heater (4), respectively;
wherein the control method comprises, in a first mode, steps of:
during at least a first fraction (T₁) of the control period operating simultaneously the first switching converter (17; 117) with a first switching frequency value (f_{SW1}) and the second switching converter (18; 118) with a second switching frequency value (f_{SW2}), wherein a switching frequency difference (Δf) between the two switching frequencies values (f_{SW1}, f_{SW2}) is greater than zero and is equal to a value comprised between a first frequency threshold (Δf₁) and a second frequency threshold (Δf₂) or is above a third frequency threshold (Δf₃).

12. A method according to claim 11, wherein, in the first mode, the control period (T) comprising a second fraction (T₂) in addition to the first fraction (T₁); wherein during the second fraction (T₂) of the control period (T) the method comprises the step to operate only one of the first and second switching converter (17, 18; 117; 118) with a third frequency value (f_{SW3}); wherein the third switching frequency value (f_{SW3}) is equal to the first switching frequency value (f_{SW1}) or the second switching frequency value (f_{SW2}), or different from the first switching frequency value (f_{SW1}) or the second switching frequency value (f_{SW2});
wherein the other of the first and second switching converter (17, 18; 117; 118) being not operating or halting or idling; and
wherein the first fraction (T₁) of the control period (T) and the second fraction (T₂) of the control period (T) are not overlapping.

13. A method according to claim 11, wherein, said frequency switching difference (Δf) is not equal to an integer multiple of the alternate current frequency of the Main feeding the induction cooktop and is not an integer multiple of 50 Hz or 60 Hz.

14. A method according to claim 11, wherein the control method comprises a plurality of working modes comprising the first mode and at least a second mode, and in the second mode the control method comprises the steps of:
operating the first switching converter (17; 117) with a fourth switching frequency value (f_{SW4}) in a first fraction (T₁) of the control period (T) while the second switching converter (18) is not operating;
operating the second switching converter (18; 118) with a fifth switching frequency value (f_{SW5}) in a second fraction (T₂) of the control period (T) while the first switching converter (18) is not operating; wherein the first fraction (T₁) of the control period (T) and the second fraction (T₂) of the control period (T) are not overlapping;
wherein the duration of the sum of the first fraction and the second fraction of the control period is equal to the duration of the control period.

15. A method according to claim 11, wherein, in the first mode, the method comprises the step of determining the at least a first fraction (T₁) of the control period (T) from the following sets of equations:
$$\{ \begin{matrix}{P}_{A} = \{ {P}_{A} ( {f}_{sw 1} ) * {T}_{1} + {P}_{A} ( {f}_{sw 3} ) * {T}_{2} \} / T \\ {P}_{B} = \{ {P}_{B} ( {f}_{sw 2} ) * {T}_{1} \} / T\end{matrix} \\ Or \\ \{ \begin{matrix}{P}_{A} = \{ {P}_{A} ( {f}_{sw 1} ) * {T}_{1} \} / T \\ {P}_{B} = \{ {P}_{B} ( {f}_{sw 2} ) * {T}_{1} + {P}_{B} ( {f}_{sw 3} ) * {T}_{2} \} / T\end{matrix}$$
wherein: P_{A} and P_{B} are a first power value request and a second power value request for the first induction heater (3) and the second induction heater (4), respectively; P_{A}(f_{SW1}), P_{A}(f_{SW3}) indicate power delivered by the first induction heater (3) when operated at the first switching frequency value (f_{SW1}) and at the third switching frequency value (f_{SW3}), respectively; P_{B}(f_{SW2}) and P_{B}(f_{SW3}) indicate power delivered by the second induction heater (4) when operated at the second switching frequency value (f_{SW2}) and at the third switching frequency value (f_{SW3}), respectively; T₁ and T₂ are the respective fractions of the control period T.

16. A control method according to claim 11, wherein the control method is configured to operate according to the first mode when a point, on a chart (C), defined by the couple of first and the second power values request (P_{A}, P_{B}) of the first induction (3) and the second inductor (4) lies above a first line (PRₘₐₓ) on said chart (C); wherein on the chart (C) on the x-axis are reported first power values request (P_{A}) for the first induction heater (3) and on the y-axis are second power values request (P_{B}) for the second induction heater (4); wherein the first line (PRₘₐₓ) is defined as the line passing by the points P_{A}=0, P_{B}=P_{Bmax} and P_{A}=P_{Amax}, P_{B}=0 on the said chart (C); wherein P_{Amax} being the maximum power that the first switching converter (17) can feed to the first inductor (3) and P_{Bmax} being the maximum power that the second switching converter (18) can feed to the second inductor (4); wherein the chart (C) is stored in a memory of the control unit (15).

17. An induction cooktop according to claim 1, wherein the first switching converter (17; 117) and the second switching converter (18; 118) are operable cyclically.

18. An induction cooktop according to claim 2, wherein the third switching frequency value (f_{SW3}) is equal to the first switching frequency value (f_{SW1}) or the second switching frequency value (f_{SW2}), or different from the first switching frequency value (f_{SW1}) or the second switching frequency value (f_{SW2}).

19. An induction cooktop according to claim 2, wherein the other of the first and second switching converter (17, 18; 117; 118) is not operating or halting or idling.

20. An induction cooktop according to claim 3, wherein said switching frequency difference (Δf) is not an integer multiple of 50 Hz or 60 Hz.
